(19) United States
(12) Patent Application Publication
(10) Pub. No.: US 2017/0288857 A1
(43) Pub. Date: Oct. 5, 2017

(54) DATA ENCRYPTION TO ENSURE DATA IS CORRECTLY BEING ACCESSED

(71) Applicant: Whole Body IQ, Inc., Monte Sereno, CA (US)

(72) Inventors: Paul J. Zuhorski, Monte Sereno, CA (US); Marianne C. Zuhorski, Monte Sereno, CA (US); Gregory L. Wade, San Jose, CA (US)

(21) Appl. No.: 15/472,761

(22) Filed: Mar. 29, 2017

Related U.S. Application Data
(60) Provisional application No. 62/314,478, filed on Mar. 29, 2016.

(51) Int. Cl. H04L 9/06; H04L 9/16

(52) U.S. Cl. CPC H04L 9/06; H04L 9/16

(57) ABSTRACT

Embodiments disclosed herein provide systems, methods, and computer readable media for encrypting data to ensure that portions of the subject data are correctly accessed. In a particular embodiment, a method provides identifying a first portion of the subject data to be accessible using a first access key. The method further provides encrypting the first portion using a subject key and encrypting the first portion using the first access key. Also, the method provides identifying a second portion of the subject data to be accessible using a second access key. The method then provides encrypting the second portion using the subject key and encrypting the second portion using the second access key.

### RELATED APPLICATIONS

This application is related to and claims priority to U.S. Provisional Patent Application 62/314,478, titled “DATA ENCRYPTION TO ENSURE DATA IS CORRECTLY BEING ACCESSED,” filed Mar. 29, 2016, and which is hereby incorporated by reference in its entirety.

### TECHNICAL BACKGROUND

Encrypting data is a means for securing information stored in that data from being accessed by systems that do not have authorization to do so. Authorized systems are provided with an encryption key that can be used to decrypt the data. However, in some cases, as may be caused by human error, the wrong data may be accessed by a system having the proper encryption key to decrypt that data. For example, multiple items of information may be included in data that is encrypted using a common encryption key. In those situations, the encryption is unable to prevent the system from accessing information that is not the information it intended to access.

### OVERVIEW

Embodiments disclosed herein provide systems, methods, and computer readable media for encrypting data to ensure that portions of the subject data are correctly accessed. In a particular embodiment, a method provides identifying a first portion of the subject data to be accessible using a first access key. The method further provides encrypting the first portion using a subject key and encrypting the first portion using the first access key. Also, the method provides identifying a second portion of the subject data to be accessible using a second access key. The method then provides encrypting the second portion using the subject key and encrypting the second portion using the second access key.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a data encryption environment in an example scenario for encrypting data to ensure that portions of the subject data are correctly accessed.

FIG. 2 illustrates a method of operating the data encryption environment for encrypting data to ensure that portions of the subject data are correctly accessed.

FIG. 3 illustrates an example scenario for encrypting data to ensure that portions of the data are correctly accessed.

FIG. 4 illustrates a data encryption system scenario for encrypting data to ensure that portions of the subject data are correctly accessed.

### DETAILED DESCRIPTION

Many different algorithms exist for encrypting data. Most, if not all, of these algorithms encrypt data based on some form of an encryption key. For example, the encryption key may comprise a particular sequence of characters. Possession of the encryption key allows a system to decrypt the encrypted data. The encrypted data is therefore protected from being accessed by those who do not possess the encryption key.

In some situations, different items of information may be included in data encrypted using the same encryption key. For example, a user may have access to many different items of information that are all encrypted using the same encryption key. Thus, even if the user requests one item of information and receives another item instead, the user will still be able to decrypt the data containing the other item of information. That other item of information may then be used in place of the requested information, which could cause problems for the user. For instance, if the user is a medical professional, treating one patient based on another patient's information could be detrimental to that patient.

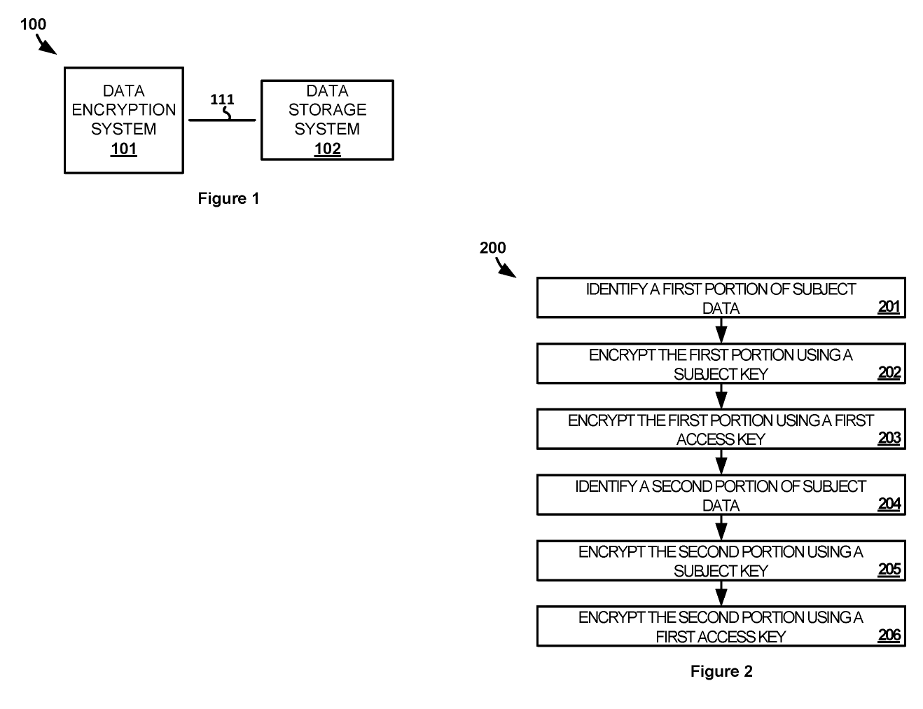

FIG. 1 illustrates data encryption environment 100 in an example scenario for encrypting data to ensure that portions of the subject data are correctly accessed. Data encryption environment 100 includes data encryption system 101 and data storage system 102. Data encryption system 101 and data storage system 102 communicate over communication link 111.

FIG. 2 illustrates method 200 of data encryption environment 100 to encrypting data to ensure that portions of the subject data are correctly accessed. Data encryption system 101 identifies a first portion of the subject data to be accessible using a first access key (step 201). The subject data may be retrieved from data storage system 102 (which may be local or accessed over a communication network), received from another system over a communication network, received via input by a user, or may be obtained from some other source. The subject data includes information that should be encrypted using a common encryption key, designated the subject encryption key herein. For example, the subject data may include information about a person, project, company, or any other type of relation for which a common encryption key may be appropriate—including combinations thereof.

The first portion of the subject data includes at least a subset of the information included in the subject data. In particular, the first portion includes any information that should be encoded using the first access key. The first access key may be associated with a system or user that is authorized to access the information included in the first portion of the data while not necessarily authorized to access information of the subject data outside of the first portion.

Once the first portion of data has been identified, data encryption system 101 encrypts the first portion using the subject key (step 202) and encrypts the first portion using the first access key (step 203). It does not matter whether step 202 or step 203 occurs first as long as the reversed order is used to decrypt the data. For example, if the first portion is first encrypted using the first access key and then that encrypted first portion is encrypted again using the subject key, then the now double encrypted first portion needs to first be decrypted using the subject key before decrypting again using the first access key. The type of encryption used for each step 202 and 203 may be different, such as different algorithms or different encryption levels of the same algorithm.

Additionally, data encryption system 101 identifies a second portion of the subject data to be accessible using a second access key (step 204). The second portion of the subject data includes at least another subset of the information included in the subject data. In particular, the second portion includes any information that should be encoded using the second access key. The second access key may be associated with a system or user that is authorized to access the information included in the second portion of the data while not necessarily authorized to access information of the subject data outside of the second portion. The second portion may include some or all of the first portion of the subject data.

Once the second portion of the subject data has been identified, data encryption system 101 encrypts the second portion using the subject key (step 205) and encrypts the second portion using the second access key (step 206). As was the case with steps 202 and 203, steps 205 and 206 may be performed in any order, as long as the reversed order is used to decrypt the second portion, and may use different types of encryption. If the second portion does include some or all of the first portion, then an unencrypted copy of the data shared between the first and second portion should be used for steps 205 and 206. The first and second portions may then be stored in data storage system 102, transferred to another system, or handled in some other manner—including combinations thereof.

After being encrypted twice, a system must be in possession of both the first and the subject keys to decrypt the first portion and/or much be in possession of both the second and the subject keys to decrypt the second portion. The keys may be provided to a decrypting system from data encryption system 101, via user input into the decrypting system, or from some other source—including combinations thereof.

It should be understood that, while the above example describes only two portions of the subject data, additional portions of the subject data may also be encrypted using the subject key and additional respective access keys. Likewise, while the first and second portions described in method 200 are only encrypted twice using two respective keys, additional encryption passes may be performed on each data portion using additional keys.

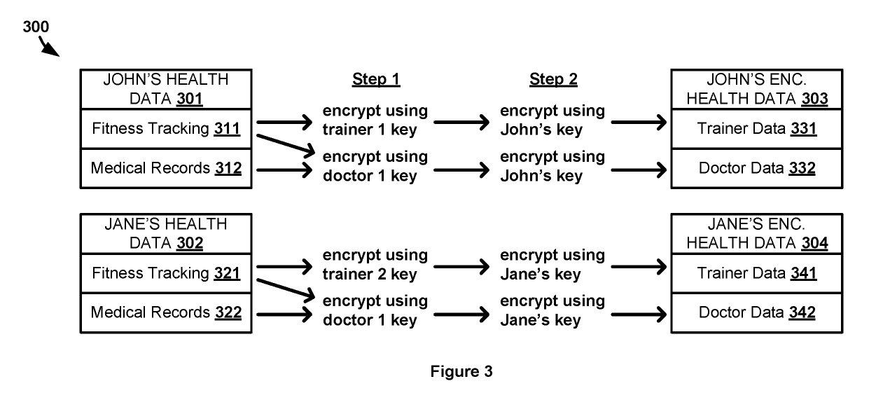

FIG. 3 illustrates an example scenario 300 for encrypting data to ensure that portions of the data are correctly accessed. Two sets of subject data are provided in this example, John's health data 301 and Jane's health data 302. Data storage system 102 may store both John's health data 301 and Jane's health data 302, which may be updated with new information periodically or when otherwise available. For example, fitness tracking information 311 may be updated each time John works out and medical record information 312 may be updated when a doctor has information to add or amend.

In this example, both John's health data 301 and Jane's health data 302 are encrypted for authorizing access by a personal trainer or a doctor/doctor's office. John and Jane use the same doctor (or at least the same doctor's office) but go to different personal trainers. Accordingly, the encryption key securing data for the doctor, doctor 1 key, is the same for both John and Jane, while the personal trainer keys are different, trainer 1 key and trainer 2 key, respectively.

Therefore, with respect to John's health data 301, fitness tracking information 311 is determined to be the portion of John's health data 301 that trainer 1 will be authorized to access while both fitness tracking information 311 and medical record information 312 is determined to be the portion of John's health data 301 that doctor 1 will be authorized to access. Accordingly, at step 1, one copy of the portion of John's health data 301 that includes fitness tracking information 311 is encrypted using the trainer 1 key. Also, another copy of the portion of John's health data 301 that includes fitness tracking information 311 along the portion of John's health data 301 that includes medical record information 312 is encrypted using the doctor 1 key.

It should be understood that, at step 1, fitness tracking information 311 and medical record information 312 may be encrypted as a whole (or even combined as may be the case for doctor 1) or may be encrypted in smaller increments (e.g. individual items of information or groups of items).

Each of those now encrypted data portions are then encrypted again using an encryption key designated for all data pertaining to John, John's key, at step 2. The resulting twice encrypted data is stored as John's encrypted health data 303 which includes encrypted trainer data 331 and encrypted doctor data 332. In other examples, both encrypted trainer data 331 and encrypted doctor data 332 may not be stored together as one encrypted data set. Rather, encrypted trainer data 331 and encrypted doctor data 332 may be stored separately, encrypted trainer data 331 may be transferred to one storage system while encrypted doctor data 332 is transferred to another storage system, or some other action may be performed with encrypted trainer data 331 and/or encrypted doctor data 332—including combinations thereof.

Jane's health data 302 is also encrypted in a similar manner to that of John's health data 301. However, fitness tracking information 321 of Jane's health data 302 is encrypted using the key, trainer 2 key, for Jane's personal trainer at step 1. Fitness tracking information 321 and medical record information 322 are also encrypted using the doctor 1 key at step 1. It should be understood that if Jane did not see the same doctor (or doctor's office) as John, then a key different than the doctor 1 key may be used. The two encrypted portions are then each encrypted again using an encryption key designated for data pertaining to Jane, Jane's key, at step 2. The resulting twice encrypted data is stored as Jane's encrypted health data 304, which includes encrypted trainer data 341 and encrypted doctor data 342. As was the case with the components of John's encrypted health data 303, encrypted trainer data 341 and encrypted doctor data 342 are not necessarily stored as Jane's encrypted health data 304 in all examples.

Any system wanting to access the original unencrypted information from encrypted trainer data 331, encrypted doctor data 332, encrypted trainer data 341, or encrypted doctor data 342 is required to use the respective encryption keys in reverse order to decrypt the data. For example, to access information in encrypted trainer data 331, any decryption system used by trainer 1 would need both John's key and the trainer 1 key. Trainer 1 may provide the keys to the decryption system (e.g. via typing the keys into a user interface) or the decryption system may obtain the keys from some other source. That decryption system then decrypts encrypted trainer data 331 first using John's key and then that resulting data is decrypted again using the trainer 1 key. If either of the two keys is incorrect, the decryption system will not be able to decrypt encrypted trainer data 331 back into the original data for fitness tracking information 311.

Not only does requiring two encryption keys to decrypt data add to the security of the data itself, the two encryption keys help ensure that the correct data is being accessed. For example, doctor 1, being the doctor for both John and Jane, has access to both encrypted doctor data 332 and encrypted doctor data. As such, if doctor 1 is currently treating John, then it is possible that doctor 1 may inadvertently attempt to access Jane's encrypted doctor data 342 instead of John's encrypted doctor data 332. However, since Jane's key was used to encrypt encrypted doctor data 342, encrypted doctor data 342 cannot be decrypted using John's key. Thus, doctor 1 is made aware of their error in selecting encrypted doctor data 342 instead of encrypted doctor data 332.

In scenario 300, public and private keys may be used in combination to ensure both privacy of the data from those who should not have access to the data and authenticity of the data (e.g. ensuring the data is actually John's data). Appendix A describes how private and public keys may be used in combination to store data in and access data from data storage system 102 while ensuring privacy and authenticity. Thus, only authorized people are allowed to access John or Jane's private data while ensuring the authenticity of that data actually being John or Jane's.

The embodiments discussed above may further benefit from the following discussion. As a rule, all data transmitted from an application on a user device (e.g., data encryption system 101) must be transmitted through HTTPS as a fallback mechanism for keeping communications private. Due to tools provided by companies like Proofpoint™ Secure Sockets Layer (SSL) encryption is not enough. These tools allow SSL tunnels to be pierced and data to be accessed in the clear.

As an end user inputs medical records, sensor data, medications, or other personal data the traffic between the end user application and Cloud Data Base (e.g., data storage system 102) must be encrypted beyond just using SSL in order to prevent data leakage. Communication between providers and the Cloud Data Base must also be encrypted beyond SSL for the same reason.

There are two basic forms of communications: end user to cloud database, and vice versa, and provider to cloud database, and vice versa. The end user to cloud database form occurs when an end user interacts with a mobile or web applications and creates data in a screen that must be stored in the cloud database. The reverse of this happens when data is retrieved from the cloud database and is used to populate screens in the mobile or web applications. The provider to cloud database form occurs when a provider interacts with the provider mobile or web applications and creates data in a screen that must be stored in the cloud database. The reverse of this happens when data is retrieved from the cloud database and is used to populate screens in the mobile or web applications.

In reality the two basic forms above are the same, with the data encryption system 101 operated by a user or a provider, and require the same level of data privacy and data authenticity. Without treating the communications with the same care, medical records could be accidentally disclosed or end user data could be intermixed. Intermixed data could lead to misdiagnosis or incorrect prescriptions. Even worse user data could be used by others for criminal acts.

The embodiments herein provide a privacy and authenticity encryption model. The encryption model will exclusively use public/private key encryption. The reason for doing this is to avoid the possibility of accidentally encrypting keys to the wrong users or wrong providers. In public private key encryption, the key owner never discloses their private key to any other user. However, all users can provide their public key to any other user.

Data privacy is achieved by a message originating user using the target user's public key to encrypt the communication data. Since public private key encryption is asymmetric, the only users that can decrypt data encrypted with a public key are the ones that have the private key associated with the public key. If all individual users have their own private key and never disclose their private key, then only one user can decrypt the communication data. This makes the data private between the originating user and the target user.

Data authenticity or data integrity is achieved by a message originator encrypting the data with their private key. Since private keys are not disclosed to other users, only the originating users can encrypt data with their private key. Thus, when their public key is used to decrypt data, the data is guaranteed to be the original data that was encrypted by the originator.

The model described above is, therefore, to first encrypt data for authenticity and then a second time for privacy. By doing it in this order it cannot be decrypted with the originator's public key because the second encryption process must be decrypted first. Since only the target users can decrypt for privacy no other user can decrypt for authenticity.

Referring back to FIG. 1, data encryption system 101 comprises a computer system and communication interface. Data encryption system 101 may also include other components such as a router, server, data storage system, and power supply. Data encryption system 101 may reside in a single device or may be distributed across multiple devices. Data encryption system 101 could be dedicated encryption circuitry, an application server(s), a personal computer, tablet, smartphone, or some other computing system—including combinations thereof.

Data storage system 102 comprises a data storage medium and a communication interface. The data storage medium may comprise a disk drive, flash drive, data storage circuitry, or some other non-transitory data memory apparatus—including combinations thereof. While shown separately, data storage system 102 may be incorporated with data encryption system 101.

Communication link 111 could be an internal system bus or use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), Bluetooth, High Speed Packet Access (HSPA), or some other communication format—including combinations thereof. Communication link 111 could be a direct link or may include intermediate networks, systems, or devices.

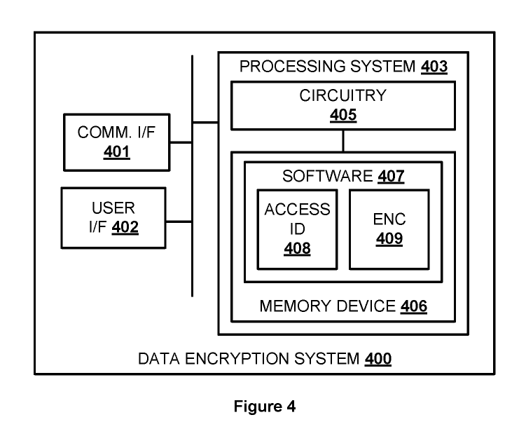

FIG. 4 illustrates data encryption system 400. Data encryption system 400 is an example of data encryption system 101, although system 101 may use alternative configurations. Data encryption system 400 comprises communication interface 401, user interface 402, and processing system 403. Processing system 403 is linked to communication interface 401 and user interface 402. Processing system 403 includes processing circuitry 405 and memory device 406 that stores operating software 407.

Communication interface 401 comprises components that communicate over communication links, such as network cards, ports, RF transceivers, processing circuitry and software, or some other communication devices. Communication interface 401 may be configured to communicate over metallic, wireless, or optical links. Communication interface 401 may be configured to use TDM, IP, Ethernet, optical networking, wireless protocols, communication signaling, or some other communication format—including combinations thereof.

User interface 402 comprises components that interact with a user. User interface 402 may include a keyboard, display screen, mouse, touch pad, or some other user input/output apparatus. User interface 402 may be omitted in some examples.

Processing circuitry 405 comprises microprocessor and other circuitry that retrieves and executes operating software 407 from memory device 406. Memory device 406 comprises a non-transitory storage medium, such as a disk drive, flash drive, data storage circuitry, or some other memory apparatus. Operating software 407 comprises computer programs, firmware, or some other form of machine-readable processing instructions. Operating software 407 includes access identifier module 408 and encryption module 409. Operating software 407 may further include an operating system, utilities, drivers, network interfaces, applications, or some other type of software. When executed by circuitry 405, operating software 407 directs processing system 403 to operate Data encryption system 400 as described herein.

In particular, access identifier module 408 directs processing system 403 to identify a first portion of the subject data to be accessible using a first access key. Encryption module 409 directs processing system 403 to encrypt the first portion using a subject key and encrypt the first portion using the first access key. Access identifier module 408 further directs processing system 403 to identify a second portion of the subject data to be accessible using a second access key. Encryption module 409 further directs processing system 403 to encrypting the second portion using the subject key and encrypt the second portion using the second access key.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of encrypting subject data to ensure that portions of the subject data are correctly accessed, the method comprising:
identifying a first portion of the subject data to be accessible using a first access key;
encrypting the first portion using a subject key;
encrypting the first portion using the first access key;
identifying a second portion of the subject data to be accessible using a second access key; and
encrypting the second portion using the subject key; and
encrypting the second portion using the second access key.
